(19) United States
(12) Patent Application Publication
(10) Pub. No.: US 2024/0172574 A1
(43) Pub. Date: May 30, 2024

(54) THREE-POINT HITCH CONTROL SYSTEM

(71) Applicant: Zimeno Inc., Livermore, CA (US)

(72) Inventors: Avery J. JUTKOWITZ, Pleasanton, CA (US); Yogesh Madhavrao CHUKEWAD, Livermore, CA (US); Zachary Meyer OMOHUNDRO, Hermosa Beach, CA (US)

(73) Assignee: Zimeno Inc., Livermore, CA (US)

(21) Appl. No.: 18/522,088

(22) Filed: Nov. 28, 2023

Related U.S. Application Data
(60) Provisional application No. 63/429,143, filed on Nov. 30, 2022.

(51) Int. Cl. A01B 59/06; G05D 1/00; G05D 1/02

(52) U.S. Cl. CPC A01B 59/067; G05D 1/0088; G05D 1/0212; G05D 2201/0201

(57) ABSTRACT

A tractor three-point hitch control system may include a tractor having a main body and a three-point hitch coupled to the main body. The three-point hitch may include a first holding arm, a second holding arm, and a top link. The system further includes a first actuator to raise and lower the first holding arm, a second actuator to raise and lower the second holding arm independent of raising and lowering the first holding arm, and a controller to output control signals to the first actuator and the second actuator to adjust an orientation of the first holding arm relative to the second holding arm.

### CROSS-REFERENCE TO RELATED PATENT APPLICATIONS

The present non-provisional application claims priority from co-pending U.S. provisional patent Application Ser. No. 63/429,143 filed on Nov. 30, 2022, by Jutkowitz et al. and entitled THREE-POINT HITCH CONTROL SYSTEM, the full disclosure of which is hereby incorporated by reference.

### BACKGROUND

Tractors often include what is known as a three-point hitch. The three-point hitch facilitates raising and lowering of an attached implement. Some tractors include a rock shaft that comprises a physical shaft that interconnects and facilitates raising and lowering of holding arms (also referred to as lower lift arms, leveling arms, or lower links) of the three-point hitch in unison.

### BRIEF DESCRIPTION OF THE DRAWINGS

FIG. 1 is a diagram schematically illustrating portions of an example three-point hitch control system on a level terrain.

FIG. 2 is a diagram schematically illustrating portions of the example three-point hitch control system of FIG. 1 on a sloped terrain.

FIG. 3 is a diagram schematically illustrating portions of the example three-point hitch control system of FIG. 1 encountering an obstacle.

FIG. 4 is a diagram schematically illustrating portions of the example three-point hitch control system of FIG. 1 during rollover mitigation on a sloped terrain.

FIG. 5 is a diagram schematically illustrating portions of an example three-point hitch control system.

FIG. 6 is a rear perspective view of portions of an example three-point hitch control system.

FIG. 7 is a rearview of the example three-point hitch control system of FIG. 6.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example three-point hitch control systems that facilitate raising and lowering of the holding arms independent of one another or relative to one another to facilitate connection of the three-point hitch to an implement and/or to accommodate uneven terrains. For example, the left holding arm may be positioned at a first height while the right holding arm is positioned at a second height different than the first height to assist in maintaining an attached implement in a proper orientation relative to the underlying terrain or ground. Because the left and right holding arms may be set to different heights relative to one another, implement may be better oriented to follow the terrain or be maintained in an orientation such that the implement rides on the ground.

Each holding arm may be provided with a separately and independently controllable actuator to pivot or raise and lower the respective holding arm. Said another way, the left holding arm may be provided with a first actuator and the right holding arm may be provided with a second separate and distinct actuator. The actuators may be in the form of hydraulic valves and cylinders, electric motors, solenoids, or pneumatic valves and cylinders. In some implementations, actuation of the independent actuators connected to the left and right holding arms may be manually controlled by an operator, such as an operator riding or driving the tractor or such as an operator remotely controlling the tractor.

In some implementations, the tractor may additionally include a sensor that senses or detects the underlying ground or terrain or a sensor that sensor detects interaction of an implement with the underlying ground or terrain. The sensor may output sensor signals which are transmitted to a controller that outputs control signals to the individual actuators of the left and right holding arms to independently raise and lower the left and right holding arms. As a result, the left and right hold arms may be automatically raised and lowered to reorient the attached implement to accommodate uneven terrain or to accommodate any detected obstacles (lifting one side of the implement so as to avoid an obstacle, such as a rock) in the path of the implement.

In some implementations, the sensor or sensors may comprise pressure sensors, force sensors, position sensors, vision sensors (cameras) or the like. Such sensors are carried by the tractor. For example, pressure sensors, force sensors and position sensors (such as potentiometers) may be operably coupled between the actuators and the respective holding arms or between the actuators and the main body of the tractor itself. Vision sensors, in the form of one or more cameras, may be mounted at a rear of the tractor to image the position of the holding arms, the actuators, the ground and/or the implement. Segmentation in other image evaluation techniques may be utilized to derive the position of the holding arms, the actuators, the ground and/or the implement from the images captured by the vision sensors.

For purposes of this application, the term “processing unit” shall mean a presently developed or future developed computing hardware that executes sequences of instructions contained in a non-transitory memory. Execution of the sequences of instructions causes the processing unit to perform steps such as generating control signals. The instructions may be loaded in a random-access memory (RAM) for execution by the processing unit from a read only memory (ROM), a mass storage device, or some other persistent storage. In other embodiments, hard wired circuitry may be used in place of or in combination with software instructions to implement the functions described. For example, a controller may be embodied as part of one or more application-specific integrated circuits (ASICs). Unless otherwise specifically noted, the controller is not limited to any specific combination of hardware circuitry and software, nor to any particular source for the instructions executed by the processing unit.

For purposes of this disclosure, unless otherwise explicitly set forth, the recitation of a “processor”, “processing unit” and “processing resource” in the specification, independent claims or dependent claims shall mean at least one processor or at least one processing unit. The at least one processor or processing unit may comprise multiple individual processors or processing units at a single location or distributed across multiple locations.

For purposes of this disclosure, the phrase “configured to” denotes an actual state of configuration that fundamentally ties the stated function/use to the physical characteristics of the feature proceeding the phrase “configured to”.

For purposes of this disclosure, unless explicitly recited to the contrary, the determination of something “based on” or “based upon” certain information or factors means that the determination is made as a result of or using at least such information or factors; it does not necessarily mean that the determination is made solely using such information or factors. For purposes of this disclosure, unless explicitly recited to the contrary, an action or response “based on” or “based upon” certain information or factors means that the action is in response to or as a result of such information or factors; it does not necessarily mean that the action results solely in response to such information or factors.

For purposes of this, unless explicitly recited to the contrary, recitations reciting that signals “indicate” a value or state means that such signals either directly indicate a value, measurement or state, or indirectly indicate a value, measurement or state. Signals that indirectly indicate a value, measure or state may serve as an input to an algorithm or calculation applied by a processing unit to output the value, measurement or state. In some circumstances, signals may indirectly indicate a value, measurement or state, wherein such signals, when serving as input along with other signals to an algorithm or calculation applied by the processing unit may result in the output or determination by the processing unit of the value, measurement or state.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature. The term “operably coupled” shall mean that two members are directly or indirectly joined such that motion may be transmitted from one member to the other member directly or via intermediate members.

FIG. 1 schematically illustrating portions of an example tractor three-point hitch control system 20. System 20 is configured to independently raise and lower left and right holding arms (also referred to as lower links or lift arms) of a three-point hitch under power, such as without manual lifting or assistance. Because the holding arms may be raised and lowered independent of one another or relative to one another, connection of the three-point hitch to an implement may be facilitated without manual lifting or assistance. Because the holding arms may be raised and lowered independent of one another, the holding arms of the three-point hitch may be moved under power to accommodate uneven terrains. For example, the left holding arm may be positioned at a first height while the right holding arm is positioned at a second height different than the first height to assist in maintaining an attached implement in a proper orientation relative to the underlying terrain or ground. Because the left and right holding arms may be set to different heights relative to one another, implement may be better oriented to follow the terrain or be maintained in an orientation such that the implement rides on the ground. System 20 comprises tractor 24, actuators 28-1, 28-2, operator interface 30, sensor 34 and controller 40.

Tractor 24 may have a variety of sizes and configurations. Tractor 24 comprises a main body 44 and a three-point hitch 46. Three-point hitch 46 comprises upper or top link 48 and holding arms 50-1, 50-2 (collectively referred to as holding arms 50). Top link 48 comprise a link pivotally coupled to main body 44 at one end and adapted to be releasably mounted to an implement at the other end. Holding arms 50 comprise links or arms pivotably coupled to main body 44 at one end and adapted to be releasably mounted to the implement at the other end. Holding arms 50 are each independently rotatably or pivotably connected to main body 44 without any link, shaft, or other structure, such as a rock shaft or rocker shaft, interconnecting the two holding arms 50 such that the two holding arms 50 may rotate or pivot relative to one another. In some implementations, each of holding arms 50 may pivot independent of one another about at least 45 degrees. Such independent relative rotation or pivoting of holding arms 50 may occur under power. Said another way, rather than simply pivoting relative to one another due to vibration or freedom of motion (the lack of a tight and restricted coupling), such relative pivoting or rotation is achieved by actuators 28 raising or lowering holding arms 50 to different positions or by different extents so as to pivot holding arms 50 by different angular extents. Holding arms 50 and top link 48 cooperate to releasably mount to an implement or attachment 54 (shown in broken lines) at three triangularly spaced connection points of the implement mount or bracket. In some implementations, three-point hitch 46 may include additional links and structures, such as sway bars (also referred to as stabilizer arms).

Actuators 28-1 and 28-2 comprise devices configured to selectively and independently raise and lower holding arms 50-1 and 50-2, respectively. Actuators 28 each comprise an actuator selected from a group of actuators consisting of: hydraulic valves and cylinders, electric motors, pneumatic valves and cylinders, solenoids or the like. Such actuators may be coupled at one end to body 44 of tractor 24 and at the other end to their respective one of holding arms 50.

Operator interface 30 (schematically illustrated) comprises one or more devices by which an operator may input information and/or commands and may receive information and such or notifications. Operator interface 30 may locally reside on tractor 24 or may be remote from tractor 24, wherein operator interface wirelessly communicates with a local controller on tractor 24 with tractor 24. Examples of operator interface 30 include, but are not limited to, a joystick, slide bar, a pushbutton, a touchscreen on a display or monitor, a microphone and associated speech recognition software, a lever or the like.

Sensor 34 (schematically illustrated) comprises one or more sensing devices carried by tractor 24 and configured to sense the current state of tractor 24, the current state of any implement or attachment connected to tractor 24, and/or the state of the environment or surroundings of tractor. Examples of sensors include, are not limited to, a global positioning satellite (GPS) antenna/receiver, an inertial measurement or motion unit, a pressure sensor, a force sensor, a position sensor, and a vision sensor such as a camera, a stereo camera or a light detection and ranging sensor (LIDAR).

Controller 40 comprises a device configured to output control signals which are transmitted to actuators 28 to cause actuators 28 to independently raise and/or lower their respective holding arms 50. In some implementations, controller 40 communicates with operator interface 30 two permit an operator to manually provide an input would cause the output of such control signals controlling the selective raising and lowering of holding arms 50 by actuators 28. For example, in some implementations, controller 40 may receive signals from a joystick, slide bar, a pushbutton, a touchscreen on a monitor, a microphone and associated speech recognition software, a lever or the like for indicating an extent or degree to which holding arm 50-1 should be raised or lowered by actuator 28-1 and an extent or degree to which holding arm 50-2 should be raised or lowered by actuator 28-2.

In some implementations, operator interface 30 may comprise a display screen depicting the current position of holding arms 50 and providing the operator with multiple selectable positions to which holding arms 50 may be repositioned relative to one another by actuators 28. For example, an operator may select a position for holding arms 50 with his or her finger or a stylus on a touchscreen or may make selections using aim cursor control by a mouse or touchpad. In some implementations, the display may provide recommended positions for holding arms 50 based upon a detected roll or angular tilt of tractor 24 (such as based upon signals from an inertial motion unit) or based upon signals from a vision sensor, such as a camera. Such adjustment may be made to a continuum of various relative positions for arms 50 or may be made between a plurality of predefined relative positions for arms 50.

In some implementations, controller 40 comprise an automated control which automatically outputs control signals to automatically cause actuators 28 to independently raise and lower holding arms 50 relative to one another based upon signals from at least one of sensors 34. In some implementations, such automated control may be based upon a combination of values or signals from multiple sensors 34. In some implementations, a first portion of the available sensors 34 may be automatically used by controller 40, based upon current operating conditions or terrain parameters, to determine appropriate heights of the holding arms 50, whereas a second portion of the sensors 34 may not be used given current operating conditions or terrain parameters. Such operating conditions or terrain parameters may be sensed and obtained by controller 40 or known to controller 40 based upon operator input. In some implementations, different weights may be applied to the values provided by the different sensors based upon confidence levels, current terrain conditions or the particular type or weight of the implement 54, wherein the differently weighted values from the multiple sensors 34 may be used by controller 140 to determine the ground interaction state of implement 54, the slope or levelness of the underlying terrain 60, the current position of holding arms 50 and/are the current extension or other position of actuators 28. In some implementations, system 120 may provide with fewer than all of those sensors 34 currently shown.

By way of one example, controller 40 may automatically output control signals causing actuators 28 to reposition holding arms 50 based upon a detected roll or angular tilt of tractor 24 (such as based upon signals from an inertial motion/measurement unit) or based upon signals from a vision sensor, such as a camera. In some implementations, controller 40 may obtain the current location or coordinates of tractor 24, such as from a GPS navigation system and use the current location or geographic coordinates to consult a topographical map of a field or other terrain being traversed by tractor 24 (and the attached implement 54 to determine the current slope or angle of the terrain being traversed at the particular moment. Based upon the current slope or angle of the terrain being traversed at the particular moment, controller 40 may automatically output control signals causing actuators 28 to independently raise and lower their respective holding arms 50.

FIG. 1 illustrates tractor 24 and the implement 54 traversing a substantially level or horizontal terrain 60. In such an implementation, controller 40 may output control signals causing actuators 28 to position lift arms 50 at substantially level positions (the same height) such that the attached implement 54 is also supported in a level orientation, matching the level terrain 60.

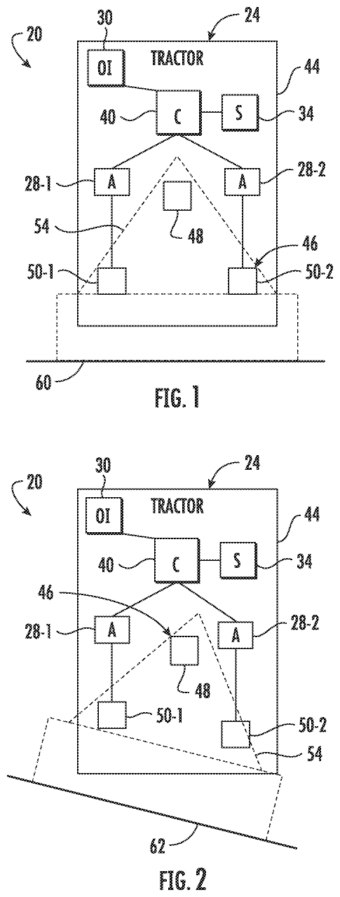

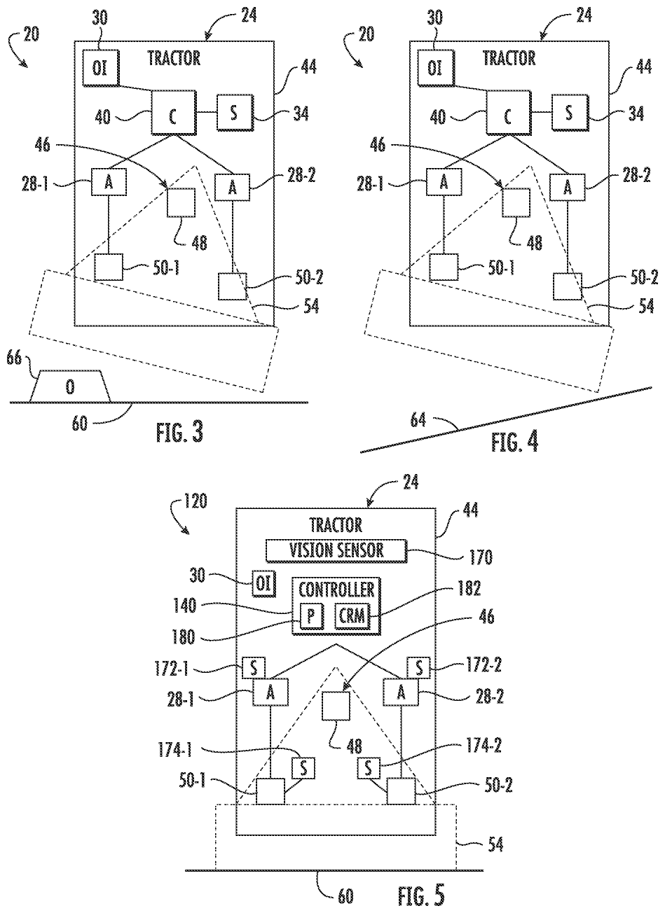

FIG. 2 illustrates tractor 24 and the implement 54 traversing a sloped terrain 62. In such an implementation, controller 40 may output control signals causing actuators 28 to differently position lift arms 50 at different heights such that the attached implement 54 is also supported in a non-level or tilted orientation, matching the sloped terrain 62. In such a manner, implement 54 may be maintained in a ground engaging or terrain following orientation.

FIG. 3 schematically illustrates tractor 24 and implement 54 traversing a substantially level or horizontal terrain 60 while encountering an obstacle 66 such as a rock or the like, to one side. In some circumstances, the obstacle 66 may be encountered while tractor 24 and implement 54 are traversing a sloped terrain, such as terrain 62. As shown by FIG. 3, in such a circumstance, controller 40 may output control signals causing actuators 28 to differently position lift arms 50 at different heights to orient the implement 54 at a tilted angle different than that of the underlying terrain (60 or 62) such that one side of the implement 54 is temporarily lifted over the obstacle. After the tractor 24 and/or the implement 54 has passed the obstacle, controller 40 may output control signals causing actuator 28 to independently reposition their respective holding arms 50 to cause the implement 54 to be supported at an orientation (level or tilted) that substantially matches the underlying terrain 60, 62. In some implementations, the detection of the obstacle 66 may be made by an operator riding tractor 24 or remotely operating tractor 24, wherein the operator utilizes manual controller 40 to accommodate the forthcoming obstacle 66. In some implementations, the detection of the obstacle 66 may be made automatically using vision sensors or other sensors carried by the tractor 24, wherein controller 40 in an automated fashion outputs control signals to automatically cause actuators 28 to independently adjust the height of holding arms 50 to accommodate the forthcoming obstacle 66.

FIG. 4 schematically illustrates tractor 24 and implement 54 traversing a sloped terrain 64. In some circumstances, the slope of terrain 64 may be so steep as to present a rollover risk for tractor 24 and/or the connected implement 54. The slope of terrain 64 may be determined by controller 40 based upon signals from at least one of sensors 34. For example, the slope of terrain 64 may be indicated by signals from an inertial measurement unit or signals from a camera depicting the terrain or horizon. An inertial measurement unit may include gyroscopes and accelerometers which indicate the orientation of tractor 24. Controller 40 may determine that a rollover risk is present by comparing the determined roll of tractor 24 from the inertial measurement unit or the determined slope of the terrain from a vision sensor/camera to a predetermined role or slope threshold.

As shown by FIG. 4, upon determining that a rollover risk may be present, controller 40 may output control signals causing actuators 28 to differently position lift arms 50 at different heights to orient the implement 54 at a tilted angle opposite to our countering that of the underlying terrain 64 such that the center of gravity or the center of mass of implement 54 is moved to the right (as seen in FIG. 4) to reduce or mitigate the chances for a rollover. Upon determining that a rollover risk is no longer present, such as when the slope of the underlying terrain is less severe as indicated by signals from a vision sensor or signals from inertial measurement unit, controller 40 may output control signals to actuators 28 to independently reposition their respective holding arms 50 to cause the implement 54 to be supported at an orientation (level or tilted) that substantially matches the underlying terrain.

FIG. 5 schematically illustrates portions of an example tractor three-point hitch control system 120. FIG. 5 illustrate an example of how the system of FIGS. 1 and 2 may additionally be provided with sensors automatic or prompted independent actuation of the holding arms. System 120 is similar to system 20 described above except that system 120 additionally comprises sensors 170, 172-1, 172-2, 174-1, 174-2, and comprises controller 140 in place of controller 40. Those remaining components of system 120 which correspond to components of system 20 are numbered similarly.

Sensor 170 comprises a vision sensor, such as a camera, carried by tractor 24. Sensor 170 is supported by tractor 24 so as to have a field-of-view encompassing at least portions of three-point hitch 46, implement 54 and/or the underlying terrain 60. Sensor 170 may output sensor signals indicating ground interaction of implement 54 which is attached to the holding arms 50. Such interaction may be the implement 54 rolling, sliding or hovering just above the surface of terrain 60 or may comprise a portion of implement 54 cutting into or digging into the underlying terrain at a predetermined depth. Sensor 170 may output sensor signals indicating the slope or levelness of the underlying terrain 60. Sensor 170 may output sensor signals indicating the current position of the holding arms 50-1, 50-2. Sensor 170 may output sensor signals indicating the current extension or other position of actuators 28.

Sensors 172-1 and 172-2 (collectively referred to as sensors 172) comprise sensors operably coupled to actuator 28-1 and 28-2, respectively. Sensors 172 may each be in the form of a pressure sensor, a force sensor or a position sensor. When a pressure sensor or force sensor, sensor 172 may output signals indicating the current pressure or force being experienced by the respective actuator 28. In one such implementation, a strain sensor may be employed. When position sensor, such as a potentiometer, sensor 172 may detect the current angular position of the actuator 28. The signals output by sensors 172 may indicate or be used by controller 140 to determine ground interaction of implement 54, the slope or levelness of the underlying terrain 60, the current position of holding arms 50 and/or the current extension or other position of actuators 28.

Sensors 174-1 and 174-2 (collectively referred to as sensors 174) comprise sensors operably coupled to holding arms 50-1 and 50-2, respectively. Sensors 174 may each be in the form of a pressure sensor, a force sensor or a position sensor. When a pressure sensor or force sensor, sensor 174 may output signals indicating the current pressure or force being experienced by the respective holding arm 50. In one such implementation, a strain sensor may be employed. When a position sensor, such as a potentiometer, each of sensors 174 may detect the current angular position of the respective holding arm 50. The signals output by sensors 174 may indicate or be used by controller 140 to determine ground interaction of implement 54, the slope or levelness of the underlying terrain 60, the current position of holding arms 50 and/or the current extension or other position of actuators 28.

In other implementations, other sensors supported by tractor 24 and/or three-point hitch 46 may be employed to indicate or facilitate the determination of grounding interaction of implement 54, the slope or levelness of the underlying terrain 60, the current position of holding arms 50 and/or the current extension or other position of actuators 28. In the example illustrated, tractor 24 may provide an operator the option of selecting (through an operator input) which of sensors 170, 172 or 174 should be utilized for the control of three-point hitch 46.

In some implementations, different sensors may be automatically used based upon current operating conditions or terrain parameters. In some implementations, different weights may be applied to the values provided by the different sensors based upon confidence levels, current terrain conditions or the particular type or weight of the implement 54, wherein the differently weighted values from the multiple sensors may be used by controller 140 to determine the ground interaction state of implement 54, the slope or levelness of the underlying terrain 60, the current position of holding arms 50 and/are the current extension or other position of actuators 28. In some implementations, system 120 may provide with fewer than all of those sensors currently shown.

Controller 140 is carried by tractor 24 and comprises processor 180 and computer readable medium 182. Processor 180 comprises a processing unit configured to carry out various computing operations based upon instructions contained on computer readable medium 182. Computer readable medium 182 comprises a non-transitory computer-readable medium in the form of software. In some implementations, processor 180 and computer readable medium 182 may be embodied as an application-specific integrated circuit. The instructions contained in computer readable medium 182 direct processor 180 to carry out a process for identifying or determining the ground interaction state of implement 54, the slope or levelness of the underlying terrain 60, the current position of holding arms 50 and/are the current extension or other position of actuators 28 based upon the signals are sensor signals from sensor 170, sensor 172 and/or sensor 174.

Instructions 182 further cause the processor 180 output control signals to actuators 28-1 and 28-2 to adjust an orientation of holding arm 50-1 relative to holding arm 50-2 based upon the sensor signals, or based upon the determined ground interaction state of implement 54, the slope or levelness of the underlying terrain 60, the current position of holding arms 50 and/are the current extension or other position of actuators 28. In some implementations, such control signals cause actuators 28 to position holding arms 50 additionally based upon an identified upcoming obstacle (as discussed above with respect to system 20). As a result, system 120 automatically adjusts the tilt or orientation of implement 54 without human intervention.

In some implementations, rather than automatically adjusting the positioning of holding arms 50, relative to one another, based upon signals from at least one of sensors 170, 172, 174, controller 140 may alternatively provide a prompt to an operator (local or remote) on a display or monitor (operator interface 30) asking for authorization or confirmation of a potentially impending adjustment of the positioning of arms 50 or implement 54. In some implementations, controller 140 may output control signals causing the recommended repositioning of control arms 50 and implement 54 to be presented on display or monitor (operator interface 30) being viewed by the operator, wherein the operator may (and using an operator input such as a pushbutton, touchscreen, control level or the like) select from amongst various recommended positioning options for arms 50 and implement 54.

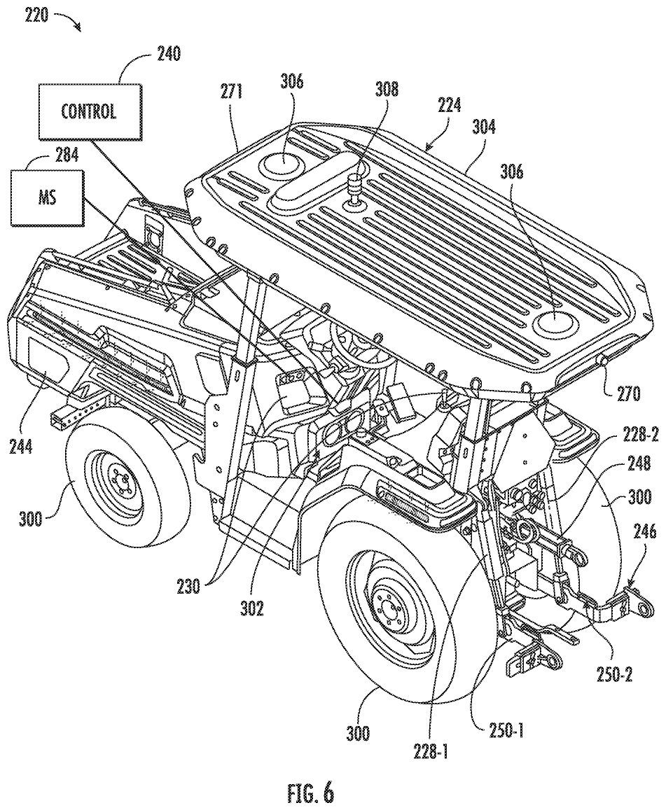

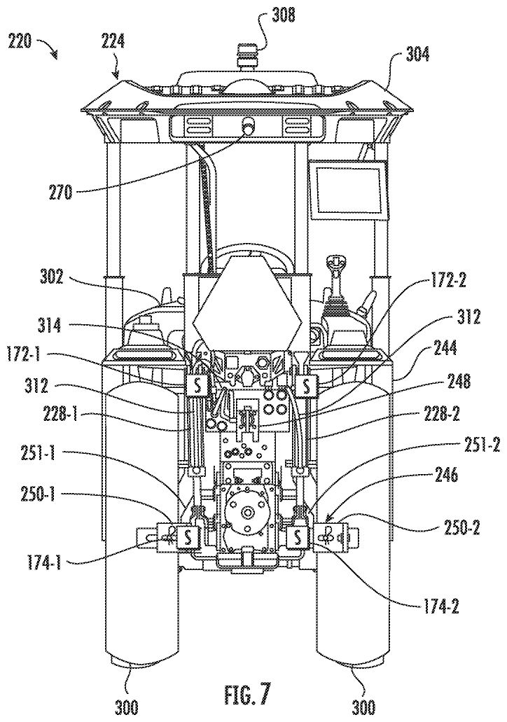

FIGS. 6 and 7 illustrate portions of an example tractor three-point hitch control system 220. FIGS. 4 and 5 illustrate a particular example of how system 120 described above may be embodied in a tractor. System 220 is similar to system 120 described above except that system 220 comprises the particular implementations of tractor 224, three-point hitch 246, actuators 228-1, 228-2 (collectively referred to as actuators 228), operator interface 230, vision sensor 270 and controller 240. Those remaining components of system 220 which correspond to components of systems 20 and 120 are numbered similarly.

Tractor 224 comprises a main body 244 movably supported by ground motive members 300 in the form of wheels. Ground motive members 300 may be driven by an internal combustion engine and/or an electric motor. In the case of an electric motor, main body 244 may support and house battery modules.

In the example illustrated, main body 244 further provides a cab 302 in which an operator may be seated. Cab 302 is covered by a roof 304. In the example illustrated, roof 304 supports inertial motion sensors 306 and a global positioning system (GPS) sensor or antenna 308. Signals from sensors 306 may be transmitted to controller 40 or controller 140 to indicate the current roll of tractor 224. Signals from antenna 308 may be transmitted to controller 40 or controller 140 to indicate or permit the determination of the current GPS coordinates or the current location of tractor 224.

Three-point hitch 246 comprises upper or top link 248 and holding arms 250-1, 250-2 (collectively referred to as holding arms 250). Holding arms 250 and top link 248 cooperate to releasably mounted to an implement or attachment 54 (shown in FIG. 1 in broken lines) at three triangularly spaced connection points of the implement mount or bracket. In some implementations, three-point hitch 246 may include additional links and structures, such as sway bars 251-1 and 251-2 (also referred to as stabilizer arms).

Top link 248 comprise a link pivotally coupled to main body 244 at one end and adapted to be releasably mounted to an implement at the other end. Holding arms 250 comprise links or arms pivotably coupled to main body 244 at one end and adapted to be releasably mounted to the implement at the other end. Although the presence or absence of any shaft, bar, or other structure, such as a rock shaft or rocker shaft, interconnecting holding arms 250 is not viewable or discernible in FIGS. 4 and 5, it should be pointed out that holding arms 250 are each independently rotatably or pivotably connected to main body 244 without any link, shaft, or other structure, such as a rock shaft or rocker shaft, interconnecting the two holding arms 250. As result, the two holding arms 250 may rotate or pivot relative to one another, not necessarily in unison with one another. In some implementations, each of holding arms 250 may pivot independent of one another about at least 45 degrees about an axis or axes which are substantially parallel to the rotational axis of ground engaging members 300. Such independent relative rotation or pivoting of holding arms 250 may occur under power. Said another way, rather than simply pivoting relative to one another due to vibration or freedom of motion (the lack of a tight and restricted coupling), such relative pivoting or rotation is achieved by actuators 228 raising or lowering holding arms 250 to different positions or by different extents so as to pivot holding arms 250 by different angular extents.

Actuators 228-1 and 228-2 comprise devices configured to selectively and independently raise and lower holding arms 250-1 and 250-2, respectively. In the example illustrated, actuators 228 each comprise a cylinder-piston assembly and associated fluid supply lines 312 and valves 314. In the example illustrated, actuator 228 each comprise a hydraulic cylinder-piston assembly with the hydraulic supply line 312 and hydraulic valves 314. In other implementations, the cylinder-piston assembly may comprise a pneumatic cylinder-piston assembly and associated pneumatic fluid supply lines 312 and pneumatic valves 314. Each of actuators 228 has a first end pivotally connected to main body 244 such as by universal ball joint or a knuckle joint. Each actuator 228 has a second end pivotally connected to its respective holding arm 250 such as with the universal ball joint or a knuckle joint. In other implementations, actuators 228 may comprise electric motors, solenoids or hydraulically, electrically or pneumatically powered linear or rotary actuators.

In the example illustrated, system 220 is equipped with sensors 172-1. 172-2 and 174-1, 174-2, each of which is schematically illustrated and described above with respect to system 120. System 220 is further equipped with vision sensor 270. Vision sensor 270 is similar to vision sensor 170 described above except the vision sensor 270 is specifically illustrated as being supported by the roof 304 of the cockpit or cab 302. Vision sensor 270 comprises a camera, a stereo camera, a light detection and ranging sensor (LIDAR) or other sensor mounted on an underside of roof 304 so as to have a downward or downward and rearward aimed field of view which encompasses at least portions of at least one of the underlying terrain, the relative positioning of actuators 228 and the relative positioning of holding arms 250. Sensor signals from each of the sensors 172, 174 and 270 are transmitted to sensor driven controller 140. The signals output by sensors 172, 174 and/or 270 may indicate or be used by controller 240 to determine ground interaction of implement 54, the slope or levelness of the underlying terrain, the current position of holding arms 250 and/or the current extension or other position of actuators 228.

In other implementations, other sensors supported by tractor 224 and/or three-point hitch 246 may be employed to indicate or facilitate the determination of ground interaction of implement 54, the slope or levelness of the underlying terrain, the current position of holding arms 250 and/or the current extension or other position of actuators 228. In the example illustrated, tractor 224 may provide an operator the option of selecting (through an operator input) which of sensors 270, 172 or 174 should be utilized for the control of three-point hitch 46. In some implementations, different sensors may be automatically used based upon current operating conditions or terrain parameters.

In some implementations, different weights may be applied to the values provided by the different sensors based upon confidence levels, current terrain conditions or the particular type or weight of the implement 54, wherein the differently weighted values from the multiple sensors may be used by controller 240 to determine the ground interaction state of implement 54, the slope or levelness of the underlying terrain, the current position of holding arms 250 and/or the current extension or other position of actuators 228. In some implementations, the weights applied to the values from different sensors may vary depending upon sensed environmental conditions, the sensed state of tractor 224 and/or implement 54, and/or the operator input or sensed type of implement currently attached to tractor 224. For example, in dusty conditions, signals from vision sensor 270 may be impaired. In such circumstances, such measurements or signals from vision sensor 270 may be provided with a lower weighting. In some implementations, controller 240 is configured to apply a first weight to the signals from the first sensor in response to first sensed data and is configured to apply a second weight to the signals from the first sensor in response to second sensed data different than the first sensed data. In some implementations, signals currently received by controller 240 from a particular sensor may result in controller 240 applying a different weight to the values associated with signals from the particular sensor. In some implementations, signals currently be received by controller 240 from a first particular sensor may result in controller 240 applying a different weight to the values associated with signals from a second different particular sensor. In some implementations, system 220 may be provided with fewer than all of those sensors currently shown.

Controller 240 is configured to perform all of the above functions described above with respect to controllers 40 and 140 as described above. Controller 240 comprises a device configured to output control signals which are transmitted to actuators 228 to cause actuators 228 to independently raise and/or lower their respective holding arms 250. In the example illustrated, controller 240 is operable in one of two operator selectable modes, a manual mode and automatic mode. In the manual mode, controller 240 permits an operator to manually provide an input that causes or triggers the output of control signals controlling the selective raising and lowering of holding arms 250 by actuators 228. For example, in some implementations, the manual control input may be provided by an operator interface 230 in the form of a joystick, slide bar, a pushbutton, a touchscreen on a monitor, a microphone and associated speech recognition software, a lever or the like for indicating an extent or degree to which holding arm 250-1 should be raised or lowered by actuator 228-1 and an extent or degree to which holding arm 250-2 should be raised or lowered by actuator 228-2. In some implementations, controller 40 may comprise a display screen depicting the current position of holding arms 250 and providing the operator with multiple selectable positions to which holding arms 250 may be repositioned relative to one another by actuators 228. In some implementations, display may provide recommended positions for holding arms 250 based upon a detected roll or angular tilt of tractor 224 (such as based upon signals from an inertial motion unit 306) or based upon signals from a vision sensor, such as vision sensor 270. Such adjustment may be made to a continuum of various relative positions for arms 250 or may be made between a plurality of predefined relative positions for arms 250.

In the automated mode, controller 240 automatically outputs control signals to automatically cause actuators 228 to independently raise and lower holding arms 250 relative to one another. Controller 240 automatically adjusts the relative positions or height of holding arms 250 based upon sensed data from one or more sensors such as inertial measurement units 306, GPS antenna 308, vision sensor 270 and sensors 174. The signals from each of such sensors may directly or indirectly indicate a particular value for a particular parameter or characteristic. Said another way, an individual signal may itself be a value or an individual signal may not represent a value but may be used by controller 40 to determine or calculate a particular value. Controller 240 may acquire a value for from a sensor directly or indirectly.

In some implementations, controller 240 may automatically carry out relative holding arm height adjustment in response to any individual value acquired from any of the individual sensors satisfying their different respective predefined thresholds. In some implementations, controller 240 may automatically carry out relative holding arm height adjustment in response to a mathematical combination or sum of acquired values from multiple sensors, wherein the mathematical combination satisfies a predetermined criteria threshold. In some implementations, controller 240 may automatically carry out relative holding arm height adjustment in response to a predetermined minimum number of acquired values from different sensors each satisfying their different respective predefined thresholds.

In some implementations, controller 240 may automatically output control signals causing actuators 228 to reposition holding arms 250 based upon a detected roll or angular tilt of tractor 224 (such as based upon signals from an inertial motion/measurement units 306) or based upon signals from a vision sensor, such as vision sensor 270. In some implementations, controller 240 may determine or acquire values corresponding to the detected roll or angular tilt of tractor 224 (or implement 54) based upon signals from inertial motion/measurement unit 306 or based upon signals from vision sensor 270.

In some implementations, controller 240 may determine values corresponding to the detected roll or angular tilt of tractor 224 (or implement 54 based upon signals from GPS antenna 308 and a topographical map. For example, controller 240 may obtain or determine the current location or coordinates of tractor 224, based upon signals from the GPS antenna 308 of a GPS navigation system and use the current location or coordinates to consult a topographical map of a field or other terrain being traversed by tractor 224 (and the attached implement 54) to determine the current slope or angle of the terrain being traversed at the particular moment. The topographical map may be stored locally or may be retrieved from a remote server or source in a wireless fashion by controller 240. Based upon the current slope or angle of the terrain being traversed at the particular moment, controller 240 may automatically output control signals causing actuators 228 to independently raise and lower their respective holding arms 250.

Upon determining the current roll or angular tilt of tractor 224 and/or implement 54, controller 240 may automatically adjust the relative positions of holding arms 252 either (1) more closely match the slope of the underlying terrain for enhanced implement interaction with the underlying terrain actor implement (such as demonstrated above with respect to FIG. 2) or (2) counter the slope of the underlying terrain to mitigate any rollover threat (demonstrated above with respect to FIG. 4).

In some implementations, the control signal may cause actuators 228 to pivot or rotate holding arms 250 such that the carried implement better follows the slope of the underlying terrain.

In some implementations, based upon the current slope of the underlying terrain, controller 240 may output control signals that cause actuators 228 to pivot or rotate holding arms 250 such that the carried implement is tilted in a direction opposite to the terrain tilt to counter any possible rollover momentum or threat. For example, in response to signals from the inertial motion/measurement units 306 indicating a degree of tilt or rollover of tractor 224 that exceeds a predefined threshold, controller 40 may output control signals that cause actuator 228 to reposition holding arms 250 such that the implement is tilted or angled so as to counter the rollover threat direction. For example, in response to signals indicating that tractor 224 is tilting or experiencing a rollover threat in a counterclockwise direction about the longitudinal axis of tractor 224 (perpendicular to the rotational axis of ground propulsion member 300), controller 240 may reposition holding arms 250 such that the implement is tilted or angled in a clockwise direction about the longitudinal axis of tractor 224. In some implementations, controller 240 may additionally output control signals that lower one or both of holding arms 250 to lower the overall height of the carried implement to further assist in reducing any rollover threat.

In some implementations, controller 240 may automatically output control signals causing actuators 228 to reposition holding arms 250 based upon the detected presence of an oncoming or forthcoming obstacle, wherein the obstacle lies in the path of tractor 224 or one side of its implement 54. Controller 240 may determine the presence of the forthcoming obstacle using signals from vision sensor 270 or a forward-facing vision sensor 271 in the form of a forward-facing camera or LIDAR sensor. As demonstrated above with respect to FIG. 3, controller 240 may automatically raise and lift the particular holding arm 50 on the side of the obstacle to a height greater than that of the obstacle. Once the implement 54 has been pulled past the obstacle (as determined by controller 240 based upon signals from vision sensor 270 or by controller 240 based upon the determined location of the obstacle in the speed and direction of tractor 224), controller 240 may automatically lower the same particular holding arm 52 once again more closely match the slope of the underlying terrain.

As described above, system 220 automatically adjusts the tilt or orientation of implement 54 without human intervention. In some implementations, system 220 may operate in a selected mode where such adjustment is not automatic, but where the operator is first notified of a “recommended” adjustment and where the adjustment made only in response to a confirming or authorizing input from the operator. Rather than automatically adjusting the positioning of holding arms 250, relative to one another, based upon signals from at least one of sensors 270, 172, 174, controller 140 may alternatively provide a prompt to an operator (local or remote) on a display or monitor of operator interface 230 asking for authorization or confirmation of a potentially impending adjustment of the positioning of arms 250 or implement 54. In some implementations, controller 240 may output control signals causing the recommended repositioning of control arms 250 and implement 54 to be presented on display or monitor being viewed by the operator, wherein the operator may (and using an operator input such as a pushbutton, touchscreen, control level or the like) select from amongst various recommended positioning options for arms 250 and implement 54.

In the example illustrated, system 220 further comprises mode selector 284. Mode selector 284 is part of operator interface 230. Mode selector 284 comprises a manual input for an operator residing in cab 302 or an electronic switch remotely controllable to actuate system 220 between different three-point hitch control modes. For example, mode selector 284 may allow a local operator or a remote operator (a “non-operator” to select between (1) the manual mode (described above), (2) the automatic mode (described above) or (3) a sensor driven mode. In the sensor driven mode, controller 240 automatically switches between the manual mode and the automatic mode based upon sensed data or other information pertaining to the current terrain or operation environment of tractor 224 and/or the type of implement being carried and manipulated by the three-point hitch. For example, controller 240 may automatically switch from one mode to another mode based upon an operator input characteristics of the implement currently being carried or pulled by the three-point hitch. Controller 240 may automatically switch between the automatic and manual modes based upon a sensed type or sensed characteristics of the implement currently being carried by the three-point hitch. Controller 240 may determine implement type or evaluate characteristics of the implement based upon signals from vision sensor 270.

Controller 240 may automatically switch between the manual and automatic modes based upon environmental conditions such as airborne particles that may impair vision, the sensed, retrieved or operator input: slope of the underlying terrain, the softness or compact ability of the underlying terrain, weather conditions, and/or the type of operation being carried out by tractor 224 or the attached implement. For example, controller 240 may operate in the automatic mode when the implement is engaging the ground and the manual mode when the implement is being raised or being transported (a road traversing circumstance). In some implementations, the sensor driven mode may be omitted.

Although the claims of the present disclosure are generally directed to independent relative adjustment of the first holding arm relative to the second holding arm, the present disclosure is additionally directed to the features set forth in the following definitions.

Definition 1. A tractor three-point hitch control system comprising:
a tractor having a main body and a three-point hitch coupled to the main body, the three-point hitch comprising:
   a first holding arm;
   a second holding arm; and
   a top link;
a first actuator to raise and lower the first holding arm;
a second actuator to raise and lower the second holding arm independent of raising and lowering the first holding arm; and
a controller to output control signals to the first actuator and the second actuator to adjust an orientation of the first holding arm relative to the second holding arm.
   Definition 2. The system of Definition 1, wherein the first actuator comprises an actuator selected from a group of actuators consisting of: hydraulic valves and cylinders, and electric motor, pneumatic valves, hydraulic cylinders and pneumatic cylinders.
   Definition 3. The system of Definition 1 further comprising a sensor to output sensor signals indicating ground interaction of an implement attached to the first holding arm and the second holding arm, wherein the controller is configured to output control signals to the first actuator and the second actuator to adjust the orientation of the first holding arm relative to the second holding arm based on the sensor signals.
   Definition 4. The system of Definition 3, wherein the sensor comprises a sensor selected from a group of sensors consisting of: a pressure sensor; a force sensor; a position sensor; and a vision sensor.
   Definition 5. The system of Definition 1, wherein the first actuator comprises a first cylinder-piston assembly having a first end portion coupled to the main body and a second end portion pivotably coupled to first holding arm.
   Definition 6. The system of Definition 1 further comprising a sensor to output sensor signals indicating a current slope of terrain being traversed by the tractor, wherein the controller is configured to output control signals to the first actuator and the second actuator to adjust the orientation of the first holding arm relative to the second holding arm based on the sensor signals.
   Definition 7. The system of Definition 1 further comprising a sensor to output sensor signals indicating a forthcoming obstacle, wherein the controller is configured to output control signals to the first actuator and the second actuator to adjust the orientation of the first holding arm relative to the second holding arm based on the sensor signals.
   Definition 8. The system of Definition 7, wherein the sensor comprises a vision sensor.
   Definition 9. The system of Definition 1 further comprising a global positioning satellite (GPS) antenna to output signals indicating geographic coordinates of the tractor, wherein the controller is configured to output control signals to the first actuator and the second actuator to adjust the orientation of the first holding arm relative to the second holding arm based on the geographic coordinates.
   Definition 10. The system of Definition 9, wherein the controller is configured to determine a current slope of terrain being traversed by the tractor based upon the geographic coordinates of the tractor and wherein the controller is configured to output control signals to the first actuator and the second actuator to adjust the orientation of the first holding arm relative to the second holding arm based on the current slope of the terrain.
   Definition 11. The system of Definition 1, wherein the controller is configured to determine a current slope of terrain being traversed by the tractor and is configured to output control signals to the first actuator and the second actuator to adjust the orientation of the first holding arm relative to the second holding arm such that an orientation of the three-point hitch more closely matches the current slope of the terrain.
   Definition 12. The system of Definition 1, wherein the controller is configured to determine a current slope of terrain being traversed by the tractor and is configured to output control signals to the first actuator and the second actuator to adjust the orientation of the first holding arm relative to the second holding arm such that an orientation of the three-point hitch is more tilted in a direction opposite to the current slope of the terrain to counter a rollover threat.
   Definition 13. The system of Definition 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input, and
wherein, when in the automatic mode, the controller is configured to output the control signals to the first actuator and the second actuator to adjust the orientation of the first holding arm relative to the second holding arm based upon sensor signals.
   Definition 14. The system of Definition 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input,
wherein, when in the automatic mode, the controller is configured to output the control signals to the first actuator and the second actuator to adjust the orientation of the first holding arm relative to the second holding arm based upon sensed data, and.
wherein the controller is configured to automatically switch between the manual mode and the automatic mode based upon signals from at least one sensor.
   Definition 15. The system of Definition 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input,
wherein, when in the automatic mode, the controller is configured to output the control signals to the first actuator and the second actuator to adjust the orientation of the first holding arm relative to the second holding arm based upon sensed data, and.
wherein the controller is configured to automatically switch between the manual mode and the automatic mode based upon a particular type of implement connected to the tractor.
   Definition 16. The system of Definition 15 further comprising a vision sensor to output signals indicating the particular type of implement connected to the tractor.
   Definition 17. The system of Definition 1 further comprising:
a first sensor; and
a second sensor, wherein the controller is configured to output the control signals to the first actuator and the second actuator to adjust the orientation of the first holding arm relative to the second holding arm based upon signals from the first sensor in response to first sensed data, and wherein the controller is configured to output the control signals to the first actuator and the second actuator to adjust the orientation of the first holding arm relative to the second holding arm based upon signals from the second sensor in response to second sensed data.
   Definition 18. The system of Definition 1 further comprising:
a first sensor; and
a second sensor, wherein the controller is configured to output the control signals to the first actuator and the second actuator to adjust the orientation of the first holding arm relative to the second holding arm based upon signals from the first sensor in response to a first implement connected to the tractor, and wherein the controller is configured to output the control signals to the first actuator and the second actuator to adjust the orientation of the first holding arm relative to the second holding arm based upon signals from the second sensor in response to a second, connected to the tractor.
   Definition 19. The system of Definition 1 further comprising:
a first sensor; and
a second sensor, wherein the controller is configured to output the control signals to the first actuator and the second actuator to adjust the orientation of the first holding arm relative to the second holding arm based upon a combination of signals from the first sensor and the second sensor, wherein signals from the first sensor and signals from the second sensor are differently weighted.
   Definition 20. The system of Definition 19, wherein the controller is configured to apply a first weight to the signals from the first sensor in response to first sensed data and is configured to apply a second weight to the signals from the first sensor in response to second sensed data different than the first sensed data.
   Definition 21. A non-transitory computer-readable medium containing instructions configured to direct a processor to output control signals to independently adjust a relative height of holding arms of a three-point hitch of a vehicle based upon at least one factor selected from a group of factors consisting of: an operator input terrain slope; a terrain slope sensed by a vision sensor; a terrain slope based upon geographic coordinates of a tractor; a roll of the tractor as sensed from an inertial measurement unit carried by the tractor; a type of implement pulled by the tractor as indicated by operator input; the type of implement pulled by the tractor as indicated by signals from a vision sensor; presence of an obstacle in a path of the tractor as indicated by operator input; presence of an obstacle in a path of the tractor as indicated by signals from a vision sensor; presence of an obstacle in a path of the tractor based upon geographic coordinates of the tractor; and a rollover threat determined based upon a comparison of a roll of the tractor or a slope of the terrain to a predefined rollover threat threshold.
   Definition 22. The medium of Definition 21, wherein the instructions are configured to direct the processor to operate in an operator selectable mode selected from a group of modes consisting of: a manual mode; an automatic mode; and a sensor driven mode selection mode.
   Definition 23. A three-point hitch control method comprising:
determining targeted relative heights for holding arms of a three-point hitch of a tractor based upon at least one factor selected from a group of factors consisting of: an operator input terrain slope; a terrain slope sensed by a vision sensor; a terrain slope based upon geographic coordinates of a tractor; a roll of the tractor as sensed from an inertial measurement unit carried by the tractor; a type of implement pulled by the tractor as indicated by operator input; the type of implement pulled by the tractor as indicated by signals from a vision sensor; presence of an obstacle in a path of the tractor as indicated by operator input; presence of an obstacle in a path of the tractor as indicated by signals from a vision sensor; presence of an obstacle in a path of the tractor based upon geographic coordinates of the tractor; and a rollover threat determined based upon a comparison of a roll of the tractor or a slope of the terrain to a predefined rollover threat threshold; and
outputting control signals to independently adjust a relative height of holding arms of a three-point hitch to the targeted relative heights.
   Definition 24. The method of Definition 23, wherein the outputting of the control signals is automatic without operator intervention.
   Definition 25. The method of Definition 23 further comprising:
presenting the targeted relative heights for the holding arms to an operator, wherein the outputting of the control signals is in response to receipt of an authorization from the operator.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A tractor three-point hitch control system comprising:
a tractor having a main body and a three-point hitch coupled to the main body, the three-point hitch comprising:
a first holding arm;
a second holding arm; and
a top link;
a first actuator to raise and lower the first holding arm;
a second actuator to raise and lower the second holding arm independent of raising and lowering the first holding arm; and
a controller to output control signals to the first actuator and the second actuator to adjust an orientation of the first holding arm relative to the second holding arm.

2. The system of claim 1, wherein the first actuator comprises an actuator selected from a group of actuators consisting of: hydraulic valves and cylinders, and electric motor, pneumatic valves, hydraulic cylinders and pneumatic cylinders.

3. The system of claim 1 further comprising a sensor to output sensor signals indicating ground interaction of an implement attached to the first holding arm and the second holding arm, wherein the controller is configured to output control signals to the first actuator and the second actuator to adjust the orientation of the first holding arm relative to the second holding arm based on the sensor signals.

4. The system of claim 3, wherein the sensor comprises a sensor selected from a group of sensors consisting of: a pressure sensor; a force sensor; a position sensor; and a vision sensor.

5. The system of claim 1, wherein the first actuator comprises a first cylinder-piston assembly having a first end portion coupled to the main body and a second end portion pivotably coupled to first holding arm.

6. The system of claim 1 further comprising a sensor to output sensor signals indicating a current slope of terrain being traversed by the tractor, wherein the controller is configured to output control signals to the first actuator and the second actuator to adjust the orientation of the first holding arm relative to the second holding arm based on the sensor signals.

7. The system of claim 1 further comprising a sensor to output sensor signals indicating a forthcoming obstacle, wherein the controller is configured to output control signals to the first actuator and the second actuator to adjust the orientation of the first holding arm relative to the second holding arm based on the sensor signals.

8. The system of claim 7, wherein the sensor comprises a vision sensor.

9. The system of claim 1 further comprising a global positioning satellite (GPS) antenna to output signals indicating geographic coordinates of the tractor, wherein the controller is configured to output control signals to the first actuator and the second actuator to adjust the orientation of the first holding arm relative to the second holding arm based on the geographic coordinates.

10. The system of claim 9, wherein the controller is configured to determine a current slope of terrain being traversed by the tractor based upon the geographic coordinates of the tractor and wherein the controller is configured to output control signals to the first actuator and the second actuator to adjust the orientation of the first holding arm relative to the second holding arm based on the current slope of the terrain.

11. The system of claim 1, wherein the controller is configured to determine a current slope of terrain being traversed by the tractor and is configured to output control signals to the first actuator and the second actuator to adjust the orientation of the first holding arm relative to the second holding arm such that an orientation of the three-point hitch more closely matches the current slope of the terrain.

12. The system of claim 1, wherein the controller is configured to determine a current slope of terrain being traversed by the tractor and is configured to output control signals to the first actuator and the second actuator to adjust the orientation of the first holding arm relative to the second holding arm such that an orientation of the three-point hitch is more tilted in a direction opposite to the current slope of the terrain to counter a rollover threat.

13. The system of claim 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input, and
wherein, when in the automatic mode, the controller is configured to output the control signals to the first actuator and the second actuator to adjust the orientation of the first holding arm relative to the second holding arm based upon sensor signals.

14. The system of claim 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input,
wherein, when in the automatic mode, the controller is configured to output the control signals to the first actuator and the second actuator to adjust the orientation of the first holding arm relative to the second holding arm based upon sensed data, and.
wherein the controller is configured to automatically switch between the manual mode and the automatic mode based upon signals from at least one sensor.

15. The system of claim 1, wherein the controller is selectively operable in a manual mode and an automatic mode,
wherein, when in the manual mode, the controller is configured to output the control signals to the first actuator and the second actuator to adjust the orientation of the first holding arm relative to the second holding arm based upon operator input,
wherein, when in the automatic mode, the controller is configured to output the control signals to the first actuator and the second actuator to adjust the orientation of the first holding arm relative to the second holding arm based upon sensed data, and.
wherein the controller is configured to automatically switch between the manual mode and the automatic mode based upon a particular type of implement connected to the tractor.

16. The system of claim 15 further comprising a vision sensor to output signals indicating the particular type of implement connected to the tractor.

17. The system of claim 1 further comprising:
a first sensor; and
a second sensor, wherein the controller is configured to output the control signals to the first actuator and the second actuator to adjust the orientation of the first holding arm relative to the second holding arm based upon signals from the first sensor in response to first sensed data, and wherein the controller is configured to output the control signals to the first actuator and the second actuator to adjust the orientation of the first holding arm relative to the second holding arm based upon signals from the second sensor in response to second sensed data.

18. The system of claim 1 further comprising:
a first sensor; and
a second sensor, wherein the controller is configured to output the control signals to the first actuator and the second actuator to adjust the orientation of the first holding arm relative to the second holding arm based upon signals from the first sensor in response to a first implement connected to the tractor, and wherein the controller is configured to output the control signals to the first actuator and the second actuator to adjust the orientation of the first holding arm relative to the second holding arm based upon signals from the second sensor in response to a second, connected to the tractor.

19. The system of claim 1 further comprising:
a first sensor; and
a second sensor, wherein the controller is configured to output the control signals to the first actuator and the second actuator to adjust the orientation of the first holding arm relative to the second holding arm based upon a combination of signals from the first sensor and the second sensor, wherein signals from the first sensor and signals from the second sensor are differently weighted.

20. The system of claim 19, wherein the controller is configured to apply a first weight to the signals from the first sensor in response to first sensed data and is configured to apply a second weight to the signals from the first sensor in response to second sensed data different than the first sensed data.
